(19) United States
(12) Patent Application Publication
(10) Pub. No.: US 2016/0339530 A1
(43) Pub. Date: Nov. 24, 2016

(54) Double Tooth Gap Cutter and Associated Cutting Insert

(71) Applicant: Caterpillar Inc., Peoria, IL (US)

(72) Inventors: Richard G. Marsh, Edwards, IL (US); Joel S. Shoffstall, Morton, IL (US)

(73) Assignee: CATERPILLAR INC., Peoria, IL (US)

(21) Appl. No.: 14/720,285

(22) Filed: May 22, 2015

(51) Int. Cl. B23F 21/14

(52) U.S. Cl. CPC B23F 21/146

(57) ABSTRACT

A gear cutter is provided that includes a body member that is configured to be rotatable about a rotational axis. A plurality of cutting inserts are mounted to the body member. The cutting inserts are arranged in a first row and a second row, the first and second rows being spaced apart from each other in the direction of the rotational axis of the body member. Each of the first and second rows of cutting inserts extends around the perimeter of the body member. Each cutting insert includes a forward face, a rear face, a base and first and second side faces, the first and second side faces being configured to converge inwardly toward each other as they extend away from the base toward a tip portion that interconnects the first and second side faces.

### TECHNICAL FIELD

This disclosure relates generally to gear manufacturing and, more particularly, to a gear cutter and associated cutting insert for generating a tooth of a gear.

### BACKGROUND

In gear manufacturing, stock is removed from a round blank material to generate the teeth. This is typically done in multiple steps including a roughing step in which stock is initially removed from the gear blank and a finishing step in which the final tooth shape is generated. These different steps often utilize different fixtures and tooling that can require parts to be moved between different machines. This can be time consuming. Moreover, the movement of parts between the different machines may require separate part lifting devices that can increase the cost and complexity of the gear manufacturing process. The switching between different fixtures and tooling for the roughing and finishing steps can also make it more difficult to hold tolerances and maintain consistency in the separate cutting operations which can lead to lower quality, out-of-tolerance gears.

One way in which the stock can be removed from the blank material to generate a tooth is using a gear cutter. Gear cutters can include a disc shaped body on which a plurality of cutting inserts are mounted. The body of the gear cutter may be rotated so as to bring the cutting inserts sequentially into engagement with the blank material and thereby cutaway material to form the teeth of the gear. Gear cutters used for finish tooling have multiple overlaid cutting inserts that are typically only capable of generating a single gear tooth at a time. The overlaid cutting inserts used on such gear cutters can be expensive to produce and require significant time and expense to maintain.

One example of a gear cutting tool is disclosed in U.S. Pat. No. 8,308,399. The disclosed cutting tool includes multiple inserts removably mounted on seats formed in a body. Each of the inserts has a single cutting face that cuts only one flank or side profile of a gear tooth at a time. The disclosed cutting tool is only used for roughing operations and different tooling is required for finishing operations.

### SUMMARY

In one aspect, the disclosure describes a gear cutter. The gear cutter includes a body member that is configured to be rotatable about a rotational axis. The body member has a perimeter. A plurality of cutting inserts are mounted to the body member. The cutting inserts are arranged in a first row and a second row, the first and second rows being spaced apart from each other in the direction of the rotational axis of the body member. Each of the first and second rows of cutting inserts extends around the perimeter of the body member. Each cutting insert includes a forward face, a rear face, a base and first and second side faces. The first and second side faces are configured to converge inwardly toward each other as they extend away from the base toward a tip portion that interconnects the first and second side faces.

In another aspect, the disclosure describes a cutting insert for a gear cutter. The cutting insert includes a body having a forward face, a rear face, a base and first and second side faces. The first and second side faces are configured to converge inwardly toward each other as they extend away from the base toward a tip portion that interconnects the first and second side faces. The first and second side faces and tip portion intersect with the forward face so as to define a cutting edge.

In yet another aspect, the disclosure describes a gear cutter. The gear cutter includes a body member that is configured to be rotatable about a rotational axis. The body member has a perimeter. A plurality of mounts are arranged around the perimeter of the body member in a first row and a second row which are spaced apart from each other in the direction of the rotational axis. A cutting insert is connected to each of the mounts such that the cutting inserts are distributed substantially evenly around the perimeter of the body member. Each cutting insert includes a forward face, a rear face, a base and first and second side faces. The first and second side faces are configured to converge inwardly toward each other as they extend away from the base toward a tip portion that interconnects the first and second side faces. The first and second side faces and tip portion intersecting with the forward face so as to define a cutting edge.

### BRIEF DESCRIPTION OF THE DRAWINGS

FIG. 1 is a side view of an exemplary gear cutter according to the present disclosure.

FIG. 2 is an end view of the gear cutter of FIG. 1.

FIG. 3 is an enlarged, partial perspective view of the gear cutter of FIG. 1 showing several cutting inserts according to the present disclosure.

FIG. 4 is an enlarged, partial perspective view of the gear cutter of FIG. 1 showing a cutting insert removed to reveal the mounting pocket for the insert.

FIG. 5 is a front perspective view of a cutting insert according to present disclosure.

### DETAILED DESCRIPTION

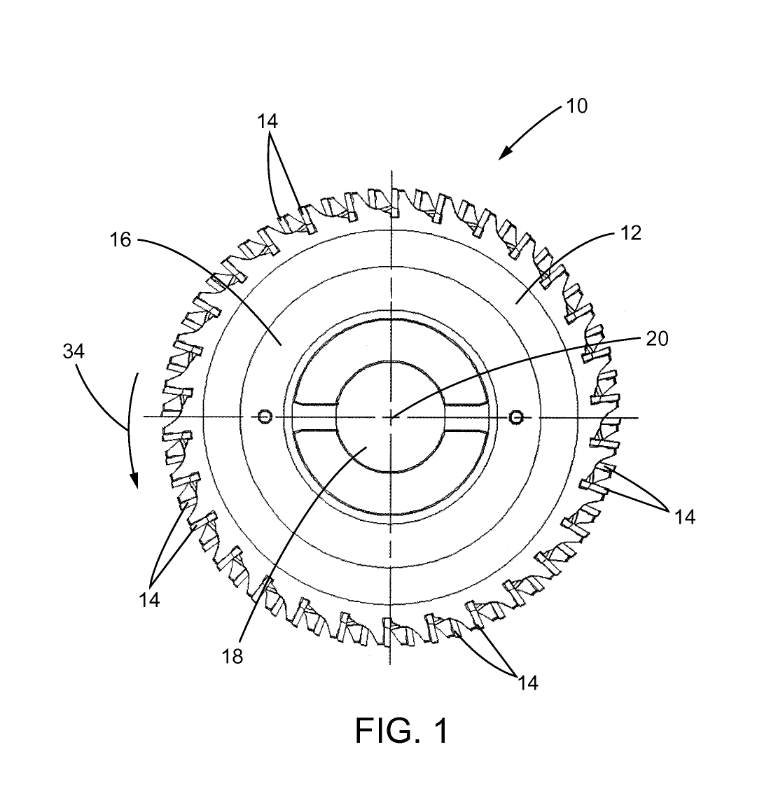

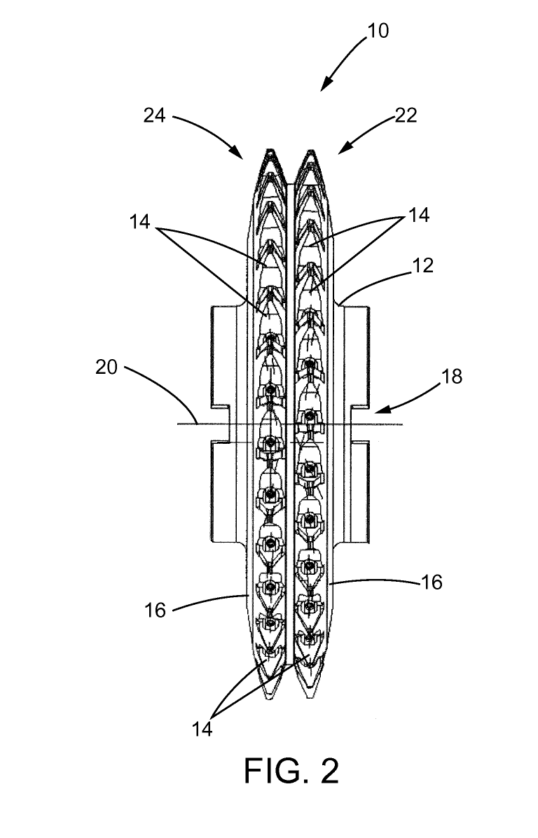

This disclosure generally relates to a gear cutter and an associated cutting insert for generating a tooth of a gear. With particular reference to FIGS. 1 and 2, an exemplary embodiment of a gear cutter 10 according to the present disclosure is shown. The illustrated gear cutter 10 is particularly suited for producing a tooth of a ring gear. For example, the illustrated gear cutter 10 may be used to generate a tooth on the inner diameter of a ring gear. However, it will be understood by those skilled in the art that the gear cutter 10 of the present disclosure is not limited to use in the formation of any particular gear type including, for example, ring gears. Rather, the gear cutter 10 may be used in the formation of any suitable gear type.

The gear cutter 10 may include a body member 12 on which a plurality of cutting inserts 14 are supported. As shown in FIGS. 1 and 2, the body member 12 may have a generally disc-like shape with opposing lateral sides 16 of substantially identical construction. The body member 12 may have a central mounting opening 18 that extends between the lateral sides 16 of the body member 12 and defines a rotational axis 20 of the gear cutter. For example, the central mounting opening 18 of the body member 12 may receive a rotatable spindle of a machine tool that may drive rotational movement of the gear cutter 10 about the rotational axis 20. The body member 12 of the gear cutter 10 may be configured so as to be rotationally symmetric with respect to the rotational axis 20. As used herein, references to the axial direction are with reference to the rotational axis 20 of the gear cutter 10 and references to the radial direction are with respect to the body member 12 of the gear cutter 10.

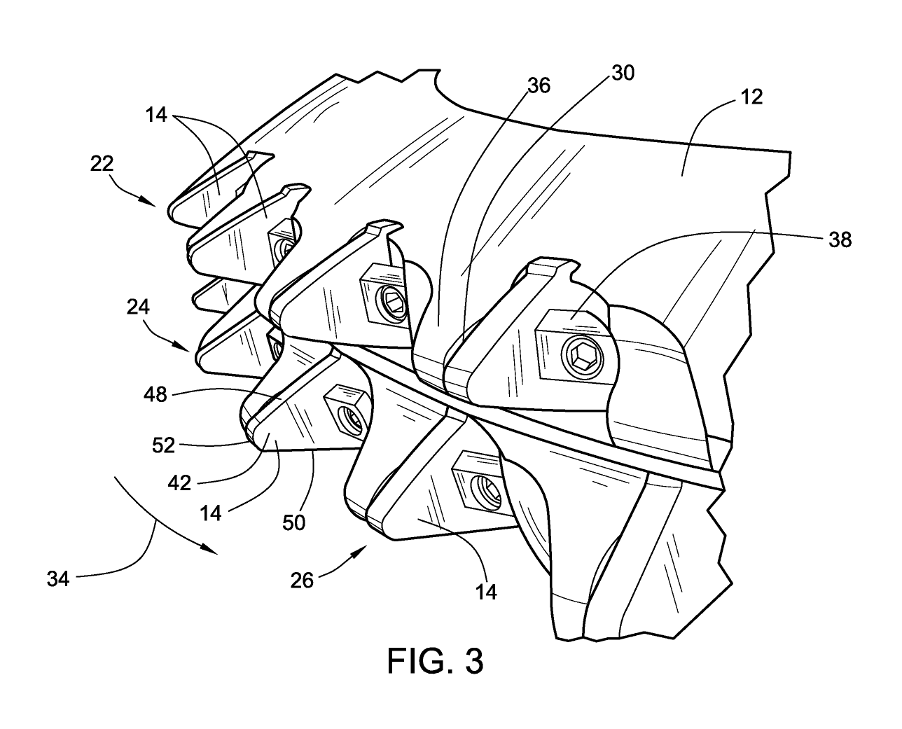

The plurality of cutting inserts 14 may be arranged about the perimeter of the body member 12 of the gear cutter 10. In the illustrated embodiment, the cutting inserts 14 are arranged in axially spaced first and second rows 22, 24 each of which includes a plurality of cutting inserts 14 and extends around the entire perimeter of the body member 12. In each of the first and second rows 22, 24, the plurality of cutting inserts 14 are spaced apart from each other in the circumferential direction of the body member 12 and are evenly distributed about the perimeter of the body member 12. As described in further detail below, each of the cutting inserts 14 may be supported on the body member 12 of the gear cutter 10 so as to protrude in a radial direction outward from the body member 12 (see, e.g., FIG. 3). In the illustrated embodiment, each of the first and second rows 22, 24 includes thirty cutting inserts 14. However, it will be appreciated by those skilled in the art, that the number of cutting inserts 14 included in each of the rows may vary depending upon the particular gear cutting application.

In the illustrated embodiment, the cutting inserts 14 in the first row 22 are arranged in staggered relationship with respect to the cutting inserts 14 in the second row 24 and vice versa as shown, for example, in FIGS. 2 and 3. In other words, the cutting inserts 14 of the first and second rows 22, 24 are not arranged directly across from each other in the axial direction. According to another embodiment, the cutting inserts 14 of the first and second rows 22, 24 may be arranged directly across from one another in the axial direction. In particular, with such a configuration, each cutting insert 14 in the first row 22 may extend in a coplanar relationship with the opposing cutting insert 14 in the second row 24. Whether the cutting inserts 14 of the first and second rows 22, 24 are arranged in a staggered or a coplanar relationship with the cutting inserts 14 of the other row may depend upon the dynamic response of the machine tool in which the gear cutter 10 is mounted.

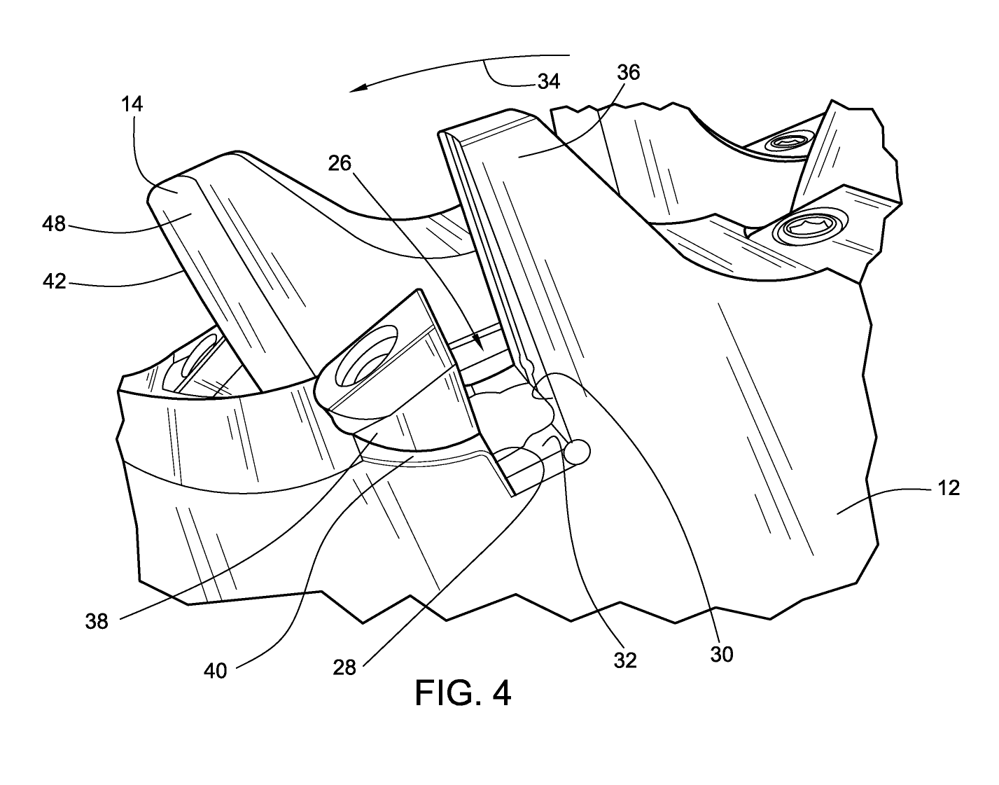

For receiving the cutting inserts 14, the body member 12 may be configured with a plurality of mounts 26 arranged around the periphery of the body member 12 of the gear cutter 10 to which the cutting inserts 14 may be connected. Moreover, each mount 26 may be configured such that the cutting inserts 14 may be easily removed and replaced, such as when the cutting insert becomes worn after use or when configuring the gear cutter 10 to cut a different type of gear. One way in which the mounts 26 may be configured are as mounting pockets such as shown in FIGS. 3 and 4, with each pocket being configured to receive a respective cutting insert 14. Another mounting arrangement that may be used for the cutting inserts 14 is a stick-type arrangement in which the mounts 26 on the body member 12 of the gear cutter 10 are configured such that the cutting inserts 14 may be attached to, for example, the outer circumference of the body member 12 via, for example, mounting openings, with the cutting inserts 14 extending outward in the radial direction, like sticks, from the body member 12. With such an arrangement, the cutting inserts 14 may be removed from the mounts 26 on the body member 12 and re-sharpened as they become dull from use. Such an arrangement is known in bevel gear cutting applications.

Referring to FIG. 4 of the drawings, one mount 26 is shown configured as a pocket with the cutting insert 14 removed. In the illustrated embodiment, the mounts 26 are arranged in two axially spaced rows around the perimeter of the body member 12 so as to produce the first and second rows 22, 24 of cutting inserts when the cutting inserts 14 are mounted to the mounts 26. Further, in the illustrated embodiment, the mounts 26 are configured such that cutting inserts 14 when connected to the mounts 26 extend in the radial direction relative to the body member 12. In other embodiments, the cutting inserts may be oriented differently relative to radii of the body member 12. When configured as a pocket, each mount 26 may be open at the radially outward end and include a forward wall 28, a rear wall 30 and a bottom wall 32. The rear wall 30 of the mount 26 may provide a support surface for the cutting insert 14 that can absorb forces exerted on the cutting insert 14 as the gear cutter 10 rotates in a cutting direction 34 (shown in FIGS. 1, 3 and 4) and the cutting insert 14 engages with a gear blank in order to cut a tooth of a gear. Moreover, the rear wall 30 of each mount 26 may be defined by a thickened flange 36 that extends rearward from the mount 26 and serves to support the respective cutting insert 14 and to separate the cutting insert 14 in the mount 26 from the succeeding cutting insert 14 and mount 26 in the circumferential direction.

When configured as pocket, each mount 26 may have an associated clamping member 38 which may be operable to help secure the cutting insert 14 in the mount 26. For example, as shown in FIG. 4, a clamping member 38 may be arranged on an inclined surface 40 at the upper edge of the forward wall 28 of the mount 26 and be configured to move in a rearward direction (i.e., towards the rear wall 30 of the mounting pocket 26) when an associated set screw is tightened relative to the clamping member 38. As the clamping member 38 moves rearward, it engages with the cutting insert 14 and helps capture the cutting insert 14 between the rear wall 30 of the mount 26 and the clamping member 38. While a specific mounting pocket configuration and clamping system is shown in the drawings, it will be appreciated by those skilled in the art that the present disclosure is not limited to a particular insert mounting system or configuration and, in particular is not limited to the use of a pocket-type arrangement. In this respect, the use of the term “insert” herein is not intended to imply the cutting insert must be mounted on the gear cutter via a mounting pocket.

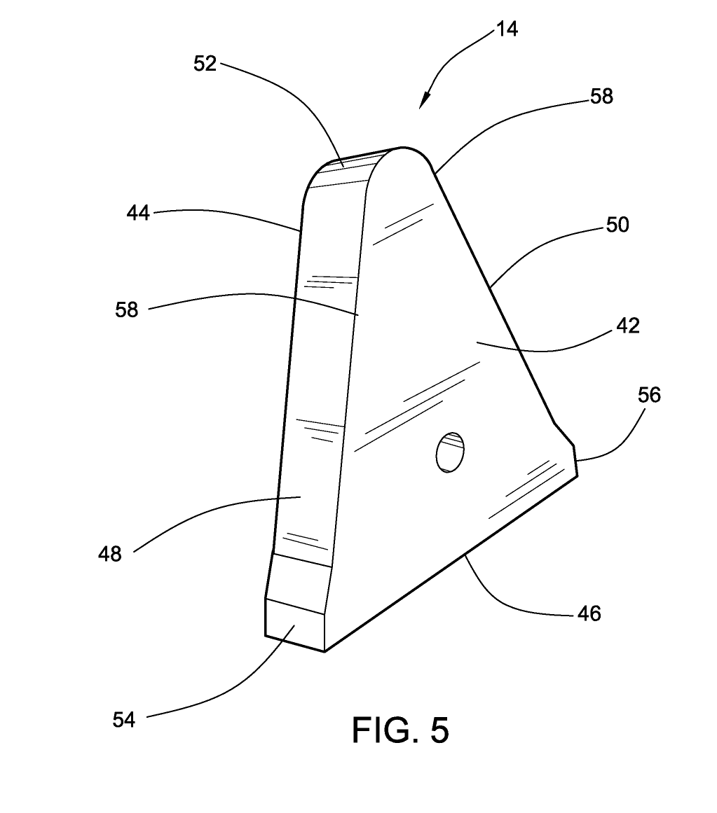

As best shown in FIG. 5, each of the cutting inserts 14 may be configured so as to be able to form the full gap between two adjacent teeth of a gear. To this end, each cutting insert 14 may have a generally triangular prism shape including a generally triangular forward face 42, a generally triangular rear face 44, a base 46 and first and second side faces 48, 50. The first and second side faces 48, 50 may be configured to converge inward towards each other as they extend upward from the base 46 to a distal tip portion 52. The distal tip portion 52 may interconnect the first and second side faces 48, 50 of the cutting insert 14 and may have a generally rounded configuration. In the illustrated embodiment, a lower portion 54, 56 of each of the first and second side faces 48, 50 of the cutting insert 14 extends in perpendicular relation upward from the base 46 of the cutting insert 14. Above these lower portions 54, 56, the first and second side faces 48, 50 converge continuously inward towards each other until reaching the tip portion 52. The illustrated cutting insert 14 has an initial section just above the lower portions 54, 56 of the first and second side faces 48, 50 in which the side faces angle toward at each other at a greater angle relative to the longitudinal axis of the cutting insert 14 than the remaining portion of the first and second side faces 48, 50.

A cutting edge 58 of the cutting insert 14 may be defined by where the first and second side faces 48, 50 and tip portion 52 intersect with the forward face 42 of the cutting insert 14. With such an arrangement, the portion of the cutting edge 58 defined by the first side face 48 may cut one flank of a gear tooth while the portion of the cutting edge 58 defined by the second side face 50 may cut one flank of the next gear tooth. The flanks of the two adjacent gear teeth may form the sides that converge to a bottom of a single gap between adjacent teeth of the gear. As will be appreciated by those skilled in the art, the precise configuration of the forward face 42, rear face 44 and first and second side faces 48, 50 of the cutting insert 14 and the resultant cutting edge 58 may be modified depending upon the particular gear configuration desired to be produced.

When received in the respective pocket-type mounts 26 shown, for example, in FIGS. 3 and 4, the cutting insert 14 may be oriented with the base 46 of the cutting insert 14 engaged with the bottom wall 32 of the mount 26 and the rear face 44 of the cutting insert 14 engaging the rear wall of the mount 26 as shown in FIG. 3. Additionally, a lower portion of the forward face 42 of the cutting insert 14 may engage with the forward wall 28 of the mount 26 with the clamping member 38 also engaging the forward face 42 of the cutting insert 14. If a stick-type mounting arrangement is to be used, the cutting insert 14 may be configured with an extended base or stem portion that is received in a corresponding mounting opening in the body member 12 of the gear cutter 14. In the illustrated embodiment, the cutting insert 14 has an opening that extends through the insert between the forward face 42 and the rear face 44. This opening may facilitate manufacture of the cutting insert 14. However, the cutting insert 14 may also be configured without any opening.

### INDUSTRIAL APPLICABILITY

The gear cutter 10 and associated cutting insert 14 of the present disclosure can be used in the generation of any type of compatible gear. During a gearing cutting operation, the gear cutter 10 may be supported so as to rotate and also move axially relative to the rotary axis of a gear blank. As the gear cutter 10 makes a single axial pass relative to the gear blank, the two rows of cutting inserts 14 on the gear cutter 10 may cut two gaps between adjacent teeth into the gear blank. Thus, the gear cutter 10 can effectively cut two gear teeth into the blank at once in a single pass of the gear cutter 10. Moreover, the use of two axially spaced rows 22, 24 of cutting inserts 14 each configured to cut the full form of a tooth gap allows the gear cutter 10 to be capable of both roughing and finishing of a gear without any change in tooling. This can be a substantial time savings as compared to tooling that can only perform the rouging or finishing step. The resultant gears produced by the gear cutter 10 also can have a higher quality because there is no need to holder tolerances and maintain consistency between separate cutting operations.

The use of cutting inserts 14 that are configured to cut the full form of a tooth gap allows spacing between same gap inserts on the gear cutter 10 to be minimized which effectively maximizes the total number of cutting inserts 14 operating on each gap. In particular, as opposed to having separate left flank and right flank cutting inserts, a single cutting insert 14 that cuts the full form of the tooth gap (i.e., simultaneously cuts both flanks) effectively allows more inserts to be arranged around the perimeter of the gear cutter 10 in that each cutting insert cuts both flanks as opposed to every other insert cutting one flank. Maximizing the number of cutting inserts operating on each gap can substantially reduce cycle times of the gear cutter.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A gear cutter comprising:
a body member that is configured to be rotatable about a rotational axis, the body member having a perimeter; and
a plurality of cutting inserts mounted to the body member, the cutting inserts being arranged in a first row and a second row, the first and second rows being spaced apart from each other in the direction of the rotational axis of the body member, each of the first and second rows of cutting inserts extending around the perimeter of the body member;
wherein each cutting insert includes a forward face, a rear face, a base and first and second side faces, the first and second side faces being configured to converge inwardly toward each other as they extend away from the base toward a tip portion that interconnects the first and second side faces.

2. The gear cutter of claim 1 wherein the body member includes a plurality of mounts with each cutting insert being connected to a corresponding one of the mounts.

3. The gear cutter of claim 2 wherein each mount is configured as a pocket and includes a rear wall that engages with the rear face of the corresponding cutting insert.

4. The gear cutter of claim 1 wherein the body member has a disc-like shape.

5. The gear cutter of claim 4 wherein each of the cutting inserts has a corresponding longitudinal axis that extends in a radial direction of the body member.

6. The gear cutter of claim 1 wherein the wherein the first and second side faces and the tip portion intersect with the forward face so as to define a cutting edge.

7. The gear cutter of claim 1 wherein the first side face and the second side face of each cutting insert includes a lower portion that extends in perpendicular relation to the base.

8. The gear cutter of claim 7 wherein the first side face and the second side face of each cutting insert converge continuously inward toward each other as they extend from their respective lower portion to the tip portion.

9. The gear cutter of claim 1 wherein the tip portion is rounded.

10. A cutting insert for a gear cutter comprising:
a body having a forward face, a rear face, a base and first and second side faces, the first and second side faces being configured to converge inwardly toward each other as they extend away from the base toward a tip portion that interconnects the first and second side faces, wherein the first and second side faces and tip portion intersect with the forward face so as to define a cutting edge.

11. The cutting insert of claim 10 wherein the first side face and the second side face of each cutting insert includes a lower portion that extends in perpendicular relation to the base.

12. The cutting insert of claim 11 wherein the first side face and the second side face of each cutting insert converge continuously inward toward each other as they extend from their respective lower portion to the tip portion.

13. The gear cutter of claim 10 wherein the tip portion is rounded.

14. A gear cutter comprising:
a body member that is configured to be rotatable about a rotational axis, the body member having a perimeter;
a plurality of mounts arranged around the perimeter of the body member in a first row and a second row which are spaced apart from each other in the direction of the rotational axis; and
a cutting insert connected to each of mounts such that the cutting inserts are distributed substantially evenly around the perimeter of the body member, wherein each cutting insert includes a forward face, a rear face, a base and first and second side faces, the first and second side faces being configured to converge inwardly toward each other as they extend away from the base toward a tip portion that interconnects the first and second side faces, the first and second side faces and tip portion intersecting with the forward face so as to define a cutting edge.

15. The gear cutter of claim 14 wherein each mount is configured as a pocket and includes a rear wall that engages with the rear face of the corresponding cutting insert.

16. The gear cutter of claim 14 wherein the body member has a disc-like shape.

17. The gear cutter of claim 16 wherein each of the cutting inserts has a corresponding longitudinal axis that extends in a radial direction of the body member.

18. The gear cutter of claim 14 wherein the first side face and the second side face of each cutting insert includes a lower portion that extends in perpendicular relation to the base.

19. The gear cutter of claim 18 wherein the first side face and the second side face of each cutting insert converge continuously inward toward each other as they extend from their respective lower portion to the tip portion.

20. The gear cutter of claim 14 wherein the tip portion is rounded.
